(19) United States
(12) Patent Application Publication
(10) Pub. No.: US 2013/0118798 A1
(43) Pub. Date: May 16, 2013

(54) POWER SUPPLY WIRE FOR HIGH-FREQUENCY CURRENT

(71) Applicant: KYOWA ELECTRIC WIRE CO., LTD., Osaka (JP)

(72) Inventors: Hiroshi Hiraike, Sakai-shi (JP); Shinjiro Konishi, Sakai-shi (JP)

(73) Assignee: KYOWA ELECTRIC WIRE CO., LTD., Osaka (JP)

(21) Appl. No.: 13/671,803

(22) Filed: Nov. 8, 2012

(30) Foreign Application Priority Data
Nov. 10, 2011 (JP) 2011-246743

(51) Int. Cl. H01B 9/02

(52) U.S. Cl. CPC H01B 9/02
USPC 174/70 R; 174/102 D

(57) ABSTRACT

There is provided a power supply wire for high-frequency current comprises: a corrugated tube made of metal; a combined electric wire disposed inside the corrugated tube and including a plurality of unit electric wires and a sheath material, each of the unit electric wires being formed by bundling together a plurality of conductive wires individually coated with insulating films, and the sheath material covering the plurality of unit electric wires; and a gap formed between the corrugated tube and the combined electric wire.

### BACKGROUND OF THE INVENTION

1. Field of the Invention

The present invention relates to a power supply wire for high-frequency current.

2. Description of Related Art

As a shielded electric wire, a wire disclosed in Japanese Unexamined Patent Application Publication No. 2007-305416 is proposed. This electric wire has an effect of shielding an electromagnetic wave from a core wire by surrounding an outer circumference surface of the core wire with a conductive corrugated tube. In addition, this electric wire can prevent damage of the core wire incurred from outside, and therefore can be used as an electric wire for supplying power.

However, when this electric wire is used as an electric wire for supplying a high-frequency current in a frequency range of 30 kHz to 100 kHz, a current density of a current flowing through the core wire is reduced due to a skin effect, and therefore power cannot be supplied efficiently. Further, since the corrugated tube is filled with a resin layer, a pressing force generated by bending the electric wire causes the core wire therein to deform, which increases a resistance of a bent portion of the core wire. The increase of the resistance may cause ignition. Accordingly, the electric wire should be laid without being bent as much as possible.

### SUMMARY OF THE INVENTION

The present invention is made in view of the problems described above, and an object thereof is to provide a power supply wire for high-frequency current which reduces a supply loss of current affected by the skin effect and has a high degree of freedom in laying.

In a first preferred aspect, to achieve the above object, a power supply wire for high-frequency current according to the present invention includes: a corrugated tube made of metal; a combined electric wire disposed inside the corrugated tube and including a plurality of unit electric wires and a sheath material, each of the unit electric wires being formed by bundling together a plurality of conductive wires individually coated with insulating films, and the sheath material covering the plurality of unit electric wires; and a gap formed between the corrugated tube and the combined electric wire.

In a second preferred aspect of the power supply wire for high-frequency current according to the present invention, the unit electric wire includes a plurality of conductive wire bundles each of which is formed by bundling together the plurality of conductive wires.

In a third preferred aspect of the power supply wire for high-frequency current according to the present invention, the plurality of conductive wire bundles are arranged annularly.

In a fourth preferred aspect of the power supply wire for high-frequency current according to the present invention, a non-magnetic space support filler is provided at a center of the plurality of conductive wire bundles.

In a fifth preferred aspect of the power supply wire for high-frequency current according to the present invention, a gap is provided with a spacer that extends in a length direction of the corrugated tube along an outer circumference of the combined electric wire.

In a sixth preferred aspect, the power supply wire for high-frequency current according to the present invention includes a plurality of the power supply wires for high-frequency current, and the plurality of the power supply wires for high-frequency current are integrated by an external layer material.

In a seventh preferred aspect, the power supply wire for high-frequency current according to the present invention is connected to a coil, and the number of the unit electric wires connected to one terminal of the coil and the number of the unit electric wires connected to the other terminal of the coil are equal to each other.

### ADVANTAGES OF THE INVENTION

According to the power supply wire for high-frequency current, since the wire bundle of each of the unit electric wires is composed of the plurality of conductive wires which are individually coated with the insulating films, a wide surface area of the conductive wire can be provided, and therefore the influence of the skin effect can be reduced.

Further, according to the power supply wire for high-frequency current, a gap is formed between the combined electric wire and the corrugated tube. The gap relieves a pressing force incurred by the combined electric wire when the power supply wire for high-frequency current is bent, and reduces deformation of the combined electric wire. Accordingly, a partial increase of a resistance of the conductive wire caused by deformation of the combined electric wire is suppressed, so that heat generation can be prevented.

According to the power supply wires for high-frequency current, since the unit electric wire includes a plurality of conductive wire bundles each of which is formed by bundling together the plurality of conductive wires, an increase of an alternating-current resistance in a high-frequency band can be suppressed. As a result, a loss incurred in a device using the power supply wire for high-frequency current according to the present invention can be reduced.

According to the power supply wire for high-frequency current, the gap is provided with a spacer. The spacer suppresses vibrations of the combined electric wire inside the corrugated tube. Accordingly, it is possible to reduce damage to the combined electric wire caused during transportation or laying work. Furthermore, the spacer restricts movement of the combined electric wire inside the corrugated tube. Accordingly, it is possible to prevent a connecting portion between the power supply wire for high-frequency current and a connection destination from being disconnected.

According to the power supply wire for high-frequency current, since the plurality of the power supply wires for high-frequency current are integrated together, it is possible to install the plurality of power supply wires for high-frequency current at one time.

According to the power supply wire for high-frequency current, since the number of unit electric wires and the number of the other unit electric wires connected to individual terminals of the coil are equal to each other, magnetic fields generated by individual unit electric wires cancel each other in the corrugated tube so that heat generation of the corrugated tube caused by eddy currents can be prevented.

For a full understanding of the present invention, reference should now be made to the following detailed description of the preferred embodiments of the invention as illustrated in the accompanying drawings.

### BRIEF DESCRIPTION OF THE DRAWING

FIG. 1 is a cross-sectional view of a power supply wire for high-frequency current according to the present invention;

FIG. 2 is an explanatory view of a manufacturing process of the power supply wire for high-frequency current according to the present invention;

FIGS. 3(a) and 3(b) are respectively a cross-sectional view of the power supply wire for high-frequency current according to the present invention;

FIG. 4 is a cross-sectional view of another power supply wire for high-frequency current according to the present invention;

FIG. 5(a) is a cross-sectional view of another power supply wire for high-frequency current, FIG. 5(b) is a cross-sectional view of still another power supply wire for high-frequency current, and FIG. 5(c) is a cross-sectional view of yet another power supply wire for high-frequency current; and

FIG. 6 is a graph indicating a resistance characteristic according to the present invention.

### DESCRIPTION OF THE PREFERRED EMBODIMENTS

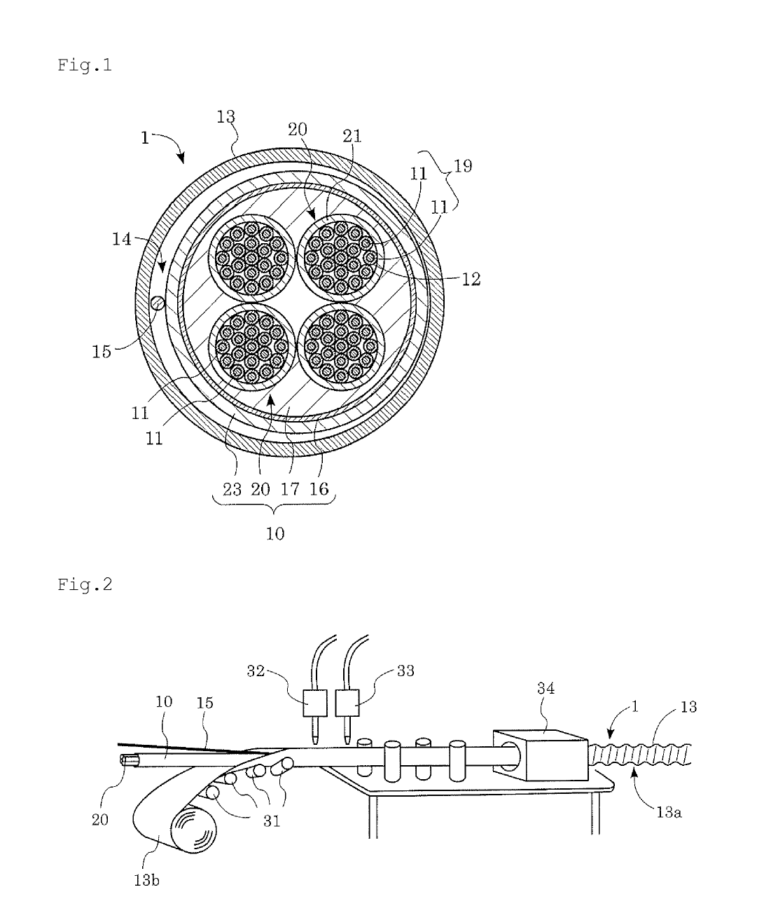

The preferred embodiments of the present invention will now be described with reference to FIG. 1 to FIG. 6 of the drawings. Identical elements in the figures are designated with the same reference numerals.

As illustrated in FIG. 1, a power supply wire 1 for high-frequency current of the present invention is configured by a corrugated tube 13 and a combined electric wire 10 disposed inside the corrugated tube 13.

The corrugated tube 13 surrounds and thereby protects the combined electric wire 10, and is a tube made of metal such as aluminum, an aluminum alloy, copper, a copper alloy, stainless steel, or steel. A bent portion 13a (FIG. 2) in a corrugated form is formed in a length direction of the tube, and the bent portion 13a is spirally formed around the tube. To prevent the corrugated tube 13 from corroding, an anti-corroding layer made of a resin, coal tar, or the like may be formed on an outer circumference surface of the corrugated tube 13. Here, a size of the corrugated tube 13 of the present invention involves, for example, a plate thickness of 0.3 mm and an outer diameter of 25.3 mm. However, the size is not limited thereto and may be arbitrarily changed according to the size of the combined electric wire 10 or a spacer 15, wiring conditions, or the like.

The combined electric wire 10 is disposed inside the corrugated tube 13, and is formed by covering an outer circumference of a plurality of twisted unit electric wires 20 with tape yarns 17 and a sheath material 23 made of a resin sequentially in this order.

The unit electric wire 20 is composed of a conductive wire bundle 19, and a sheath material 21 which is made of a resin and which covers an outer circumference of the conductive wire bundle 19. The conductive wire bundle 19 is formed by bundling together a plurality of conductive wires 11 whose surfaces are individually covered with insulating films 12. The conductive wire 11 is a metallic wire including copper or aluminum as a main component, and, for example, enamel coating can be used as the insulating film 12. For example, a Litz wire using an enameled copper wire can be used as the conductive wire bundle 19. The unit electric wire 20 is connected to a terminal of a connection destination by removing the insulating film 12 of a front end portion thereof and exposing the individual conductive wires 11.

A predetermined gap 14 is formed between the combined electric wire 10 and the corrugated tube 13. The gap 14 in the present invention refers to a gap which is formed by being surrounded by an outer circumference surface of the combined electric wire 10 and an inner circumference surface of the corrugated tube 13, and is continuously formed in a tubular axis direction of the corrugated tube 13. In the power supply wire for high-frequency current illustrated in FIG. 1, for example, the gap 14 having a clearance of 0.7 mm is formed. The gap is not limited to 0.7 mm, but can be arbitrarily changed according to the external size or the like of the combined electric wire 10 without restriction. This combined electric wire 10 is composed of, for example, four unit electric wires 20, and the unit electric wire 20 is composed of, for example, twenty two conductive wires 11. An outer diameter of the combined electric wire 10 is, for example, 20.1 mm, and an outer diameter of the unit electric wire 20 is, for example, 4.3 mm.

A plurality of tape yarns 17 are filled inside the combined electric wire 10 to prevent a position of each of the unit electric wires 20 from being displaced. The tape yarn 17 is a resin such as polyethylene or polypropylene formed in a tape shape. The tape yarns 17 are placed in a longitudinal direction along outer circumferences of the plurality of unit electric wires 20 which are bundled together, and are twisted together with the unit electric wires 20 so as to cover the outer circumferences of the bundled unit electric wires 20 to regulate an outer shape of the cross section of the combined electric wire 10 into a circular shape.

The combined electric wire 10 is not limited to the above. For example, the unit electric wires 20, without being twisted, may be bundled together by a holding tape 16 made of polypropylene to form the combined electric wire 10. Further, the size of the combined electric wire 10 may be arbitrarily changed according to a maximum rating of a connection destination of the power supply wire 1 for high-frequency current, wiring conditions, or the like. In addition, the number of the unit electric wires 20 is not limited to four, but may be arbitrarily changed. For example, if the connection destination of the power supply wire 1 for high-frequency current is a coil, an even number of the unit electric wires 20 can be used. Furthermore, to suppress an influence of the skin effect, it is preferable that a thickness of the conductive wire 11 be ½ or less of a skin depth at a frequency of a current to be fed through a coil.

The power supply wire 1 for high-frequency current of the present invention may be provided with a spacer 15. The spacer 15 is a string form made of a resin such as polyethylene. The spacer 15 is present in the gap 14 between the combined electric wire 10 and the corrugated tube 13 and extends substantially linearly in a length direction of the corrugated tube 13. The material of the spacer 15 is not limited to a resin, and a hemp cord or the like may also be used.

A manufacturing method of the power supply wire 1 for high-frequency current of an embodiment of the present invention will now be described. Manufacturing is performed sequentially from (1) to (6) described below.

(1) A plurality of conductive wires 11 which are individually coated with the insulating films 12, a metallic band-like form 13b, a plurality of tape yarns 17, and a spacer 15 are prepared (see FIG. 2).

(2) The plurality of conductive wires 11 are fed in one direction and rotated in a fixed direction by a twister (not illustrated) to thereby form the conductive wire bundle 19, and the conductive wire bundle 19 is covered with the sheath material 21 by extrusion molding to form the unit electric wire 20.

(3) The plurality of tape yarns 17 are placed in a longitudinal direction along the plurality of unit electric wires 20, which are both fed in one direction, rotated in a fixed direction, twisted together by a twister (not illustrated), and covered with the sheath material 23 by extrusion molding to form the combined electric wire 10.

(4) As illustrated on the left side in FIG. 2, the combined electric wire 10 and the spacer 15 are placed in a longitudinal direction along the band-like form 13b, which are together fed in one direction so that the band-like form 13b is bent and formed in a tubular shape to cover the combined electric wire 10 and the spacer 15 by means of forming rollers 31.

(5) As illustrated in the center of FIG. 2, tubular joint lines of the band-like form 13b are continuously welded together by a welding machine 32, and a welded portion is inspected by a welding inspection apparatus 33.

(6) As illustrated on the right side in FIG. 2, the tube is corrugated by a corrugating unit 34 as the corrugated tube 13 to thereby form the power supply wire 1 for high-frequency current.

The manufacturing method according to this embodiment is not limited to the above aspect. For example, in the step (4), a plate-like mold made of a resin and having a self-lubricating property may be used instead of the forming rollers 31 to bend and form the band-like form 13b into a tubular shape.

According to the power supply wire 1 for high-frequency current of the present invention, since the conductive wire bundle 19 of each of the unit electric wires 20 is composed of the plurality of conductive wires 11 which are individually coated with the insulating films 12, a wide surface area of the conductive wire is provided, and therefore the influence of the skin effect can be reduced.

In addition, the gap 14 formed between the combined electric wire 10 and the corrugated tube 13 relieves a pressing force incurred by the combined electric wire 10 when the power supply wire 1 for high-frequency current is bent, and reduces deformation of the combined electric wire 10. Accordingly, a partial increase of a resistance of the conductive wire caused by deformation of the combined electric wire 10 is suppressed, so that heat generation can be prevented. Additionally, it also has an effect of preventing heat caused when the joint lines of the tube are welded together by the welding machine 32 from directly transmitting to the combined electric wire 10 during manufacturing.

Further, the spacer 15 accommodated in the gap 14 suppresses vibrations of the combined electric wire 10 inside the corrugated tube 13. Accordingly, it is possible to reduce damage to the combined electric wire 10 during transportation or laying work. Furthermore, the spacer 15 restricts movement of the combined electric wire 10 inside the corrugated tube 13. Accordingly, it is possible to prevent a connecting portion between the power supply wire 1 for high-frequency current and the connection destination from being disconnected.

According to the manufacturing method of the power supply wire 1 for high-frequency current of the present invention, lengths of the conductive wire 11, spacer 15, the tape yarn 17, and the band-like form 13b are not restricted. Accordingly, it is possible to continuously manufacture the power supply wire 1 for high-frequency current having a long length. Furthermore, since bending and corrugated processing are preformed so that the gap 14 is formed between the combined electric wire 10 and the corrugated tube 13, the combined electric wire 10 is not damaged.

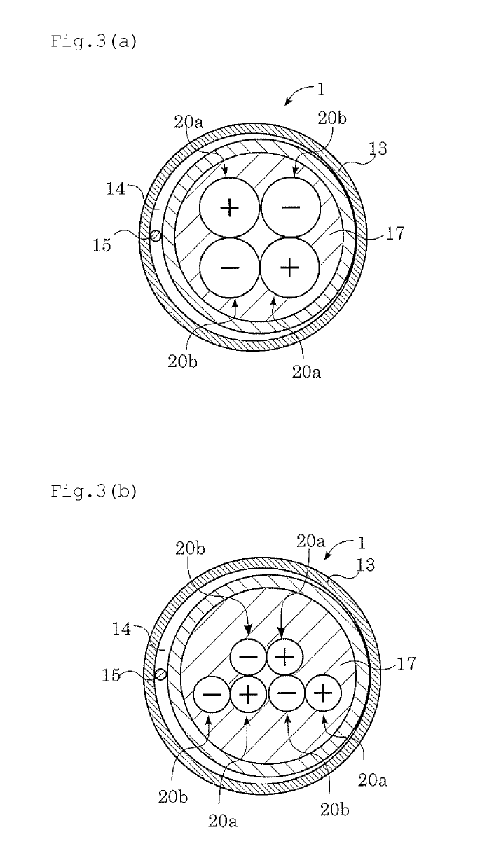

The power supply wire 1 for high-frequency current of the present invention is used, for example, as an electric wire connecting between a coil and an electric power device. The electric power device generates and outputs electric power of a high frequency (30 kHz to 100 kHz) and a large current (30 A to 50 A). As illustrated in FIG. 3(a), the combined electric wire 10 in which four unit electric wires 20a and 20b are aligned vertically and horizontally and twisted together is used. The number of unit electric wires 20a and the number of unit electric wires 20b are equal to each other, the unit electric wire 20a is connected to one connection terminal of a coil, the unit electric wire 20b is connected to the other connection terminal. The unit electric wires 20a and 20b are arranged so that unit electric wires 20a and the other unit electric wires 20b which are adjacent thereto vertically and horizontally are connected to different connection terminals. At the same time, it is preferable to fill the plurality of tape yarns 17 inside the combined electric wire 10 to maintain positions of the unit electric wires 20a and 20b thus aligned. When the unit electric wires 20a and 20b are twisted, the plurality of tape yarns 17 are placed longitudinally along the unit electric wires 20a and 20b which are vertically and horizontally aligned, and the tape yarns 17 are twisted so as to cover the outer circumferences of the unit electric wires 20a and 20b. Therefore, the unit electric wires 20a and 20b are arranged substantially at the center inside the combined electric wire 10. The number of the unit electric wires 20 is not limited to four, and only needs to be an even number. For example, as illustrated in FIG. 3(b), six unit electric wires 20a and 20b may be aligned vertically and horizontally. Further, the numbers of the conductive wires 11 individually constituting the unit electric wires 20a and 20b are equal to each other.

In this power supply wire 1 for high-frequency current, directions of currents passing through the unit electric wire 20a and the unit electric wire 20b are opposite to each other. At the same time, since the number of the unit electric wires 20a and the number of the unit electric wires 20b which are vertically and horizontally adjacent thereto are equal to each other, magnetic fields generated by the individual unit electric wires 20a and 20b cancel each other so that heat generation of the corrugated tube 13 caused by eddy currents can be prevented.

In the power supply wire 1 for high-frequency current of the present invention, the spacer 15 may be spirally wound around an outer circumference of the combined electric wire 10. At this time, in order to form the gap 14 uniformly around the combined electric wire 10, the spacer 15 is wound at an interval at least larger than a corrugated interval of the corrugated tube 13. Accordingly, the power supply wire 1 for high-frequency current can be bent in any directions.

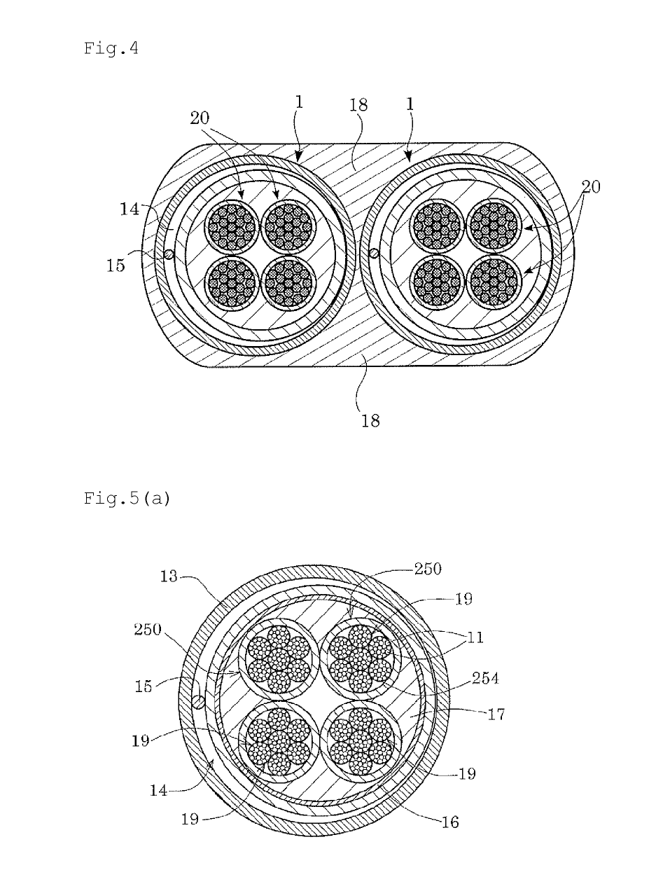

Further, for example, to facilitate installation of a plurality of power supply wires 1 for high-frequency current in such a case as burying a plurality of power supply wires 1 for high-frequency current in the ground, two of the power supply wires 1 for high-frequency current arranged parallel to each other may be integrated together by being covered with an external layer material 18, as illustrated in FIG. 4. However, the illustration is schematically simplified.

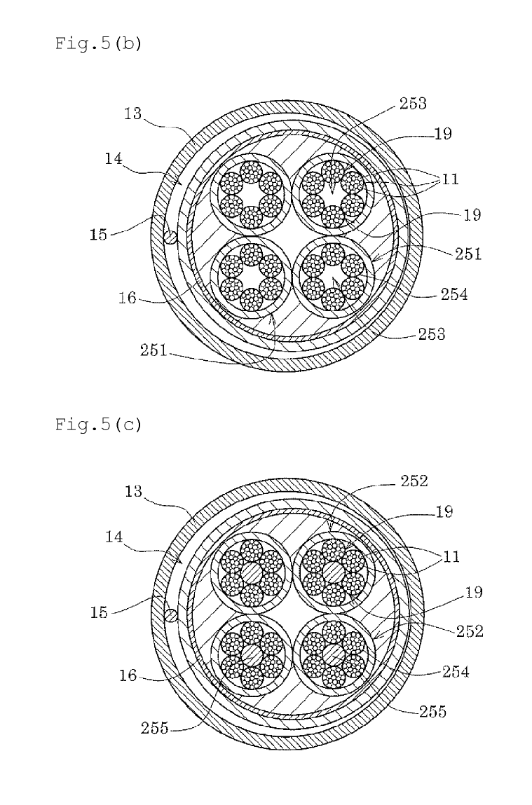

As another aspect of the unit electric wire 20 used for the power supply wire 1 for high-frequency current of the present invention, for example, a unit electric wire 250 illustrated in FIG. 5(a) may be used. The unit electric wire 250 is formed by twisting together a plurality of conductive wire bundles 19. Each of the conductive wire bundles 19 is formed by twisting together a plurality of conductive wires 11 which are individually coated with the insulating films 12. Referring to FIG. 5(a), seven conductive wire bundles 19 are used. However, the present invention is not limited thereto, and the number of the conductive wire bundles 19 may be arbitrarily determined. Further, the plurality of conductive wire bundles 19 may not be twisted together but may be simply bound together to form the unit electric wire 250. Also, in FIG. 5(a), the conductive wire bundle 19 is covered with a thin sheath material 254 made of a resin. However, the present invention is not limited thereto, and the conductive wire bundle 19 may not be covered with the sheath material 254.

It is also possible to use a unit electric wire 251 illustrated in FIG. 5(b) to eliminate a proximity effect caused by the conductive wire bundles 19 disposed at the center of the unit electric wire 250. The unit electric wire 251 is composed of a plurality of conductive wire bundles 19 arranged annularly. With this arrangement, a hollow portion 253 is continuously formed in a direction of the wire at the center of the unit electric wire 251. Accordingly, the proximity effect is not caused at the center of the unit electric wire 251, and an increase of an alternating-current resistance in a high-frequency band can be suppressed. As a result, a loss incurred in a device using the power supply wire for high-frequency current of the present invention can be reduced.

Furthermore, a unit electric wire 252 illustrated in FIG. 5(c) may be used to facilitate bundling of the plurality of conductive wire bundles 19. This unit electric wire 252 is provided with a space support filler 255 which fills the hollow portion 253 (FIG. 5(b)) which is formed by arranging the plurality of conductive wire bundles 19 annularly. The space support filler 255 is in a string shape, a linear shape, a columnar shape, or the like, and, for example, a plastic string such as polyethylene can be used.

To form, in a compact manner, each of the power supply wires for high-frequency current illustrated in FIGS. 5(a) to 5(c), each of the conductive wire bundles 19 constituting each of the unit electric wires 250, 251, and 252 may be subjected to a drawing process, and the conductive wires 11 constituting the conductive wire bundle 19 may be integrated. The integration of the conductive wires 11 herein means that the individual conductive wires 11 are deformed so as to fill in gaps formed between the conductive wires 11, and a cross-sectional shape of the conductive wire bundle 19 is formed in a circular shape or a polygonal shape. Alternatively, it is also possible to apply the drawing process to the unit electric wire 252 and integrate the individual conductive wire bundles 19 and the space support filler 255. The integration of the individual conductive wire bundles 19 and the space support filler 255 herein means that the individual conductive wire bundles 19 and the space support filler 255 are deformed so as to fill in gaps formed between the conductive wire bundles 19 and between the conductive wire bundles 19 and the space support filler 255, and a cross-sectional shape of the unit electric wire 252 is formed in a circular shape or a polygonal shape.

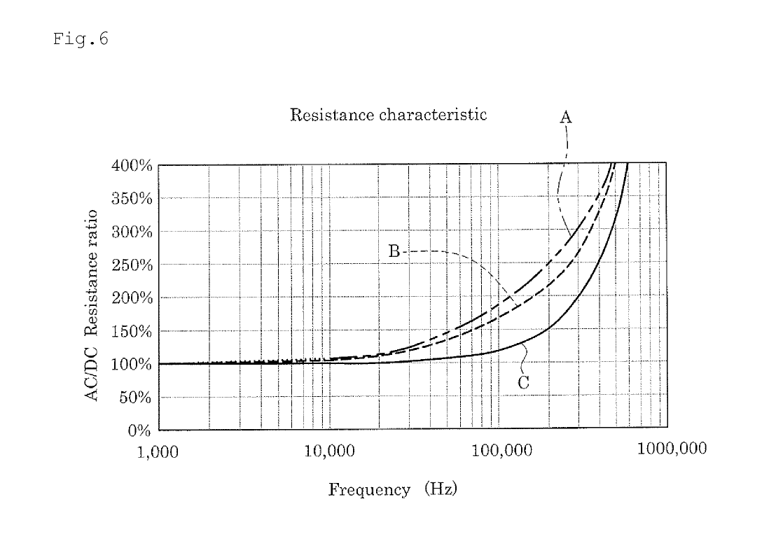

FIG. 6 illustrates a resistance characteristic of the unit electric wires at a high frequency. A horizontal axis of FIG. 6 represents a frequency (Hz), and a vertical axis represents an AC/DC resistance ratio. The AC/DC resistance ratio represents a ratio of an alternating-current resistance to a direct-current resistance.

In FIG. 6, a graph A indicated by an alternate long and two short dashes line indicates measurement values on the unit electric wire 20 (hereinafter, referred to as “unit electric wire A”) composed of the conductive wire bundle 19 (Litz wire) which is formed by twisting together 140 enameled copper wires having a cross-sectional diameter of 0.18 mm.

In FIG. 6, a graph B indicated by a broken line indicates measurement values on the unit electric wire 250 (hereinafter, referred to as “unit electric wire B”) which is formed by forming a single conductive wire bundle 19 (Litz wire) by twisting together twenty enameled copper wires having a cross-sectional diameter of 0.18 mm, preparing seven bundles of these, and arranging, around one of the conductive wire bundles 19 placed at the center, the other conductive wire bundles 19.

In FIG. 6, a graph C indicated by a solid line indicates measurement values on the unit electric wire 252 (hereinafter, referred to as “unit electric wire C”) which is formed by forming a single conductive wire bundle 19 (Litz wire) by twisting together 24 enameled copper wires having a cross-sectional diameter of 0.19 mm, preparing six bundles of these, and arranging the six bundles of the conductive wire bundles 19 around a space support filler 255 which is made of polyethylene and placed at the center.

As can be seen from FIG. 6, each of the unit electric wires has substantially a 100% resistance ratio up to a frequency of 10 kHz, and the resistance ratio starts to increase when the frequency is higher than 10 kHz.

When the frequency is 50 kHz, the resistance ratio of the unit electric wire A increases up to 145%, and the resistance ratio of the unit electric wire B increases up to 136%. In contrast, the resistance ratio of the unit electric wire C is 108%.

When the frequency is 100 kHz, the resistance ratio of the unit electric wire A increases up to 189%, and the resistance ratio of the unit electric wire B increases up to 171%. In contrast, the resistance ratio of the unit electric wire C is 119%.

When the frequency is 200 kHz, the resistance ratio of the unit electric wire A increases up to 255%, and the resistance ratio of the unit electric wire B increases up to 222%. In contrast, the resistance ratio of the unit electric wire C is 157%.

When the frequency is 500 kHz, the resistance ratio of the unit electric wire A increases up to 414%, and the resistance ratio of the unit electric wire B increases up to 400%. In contrast, the resistance ratio of the unit electric wire C is 333%.

According to the above result, the unit electric wire C has the smallest increase of resistance in the high-frequency band. Specifically, when the non-magnetic space support filler 255 is provided at the center (center of the unit electric wire) of the plurality of conductive wire bundles 19, it is possible to suppress the proximity effect caused at the center of the unit electric wire, and the increase of the alternating-current resistance of the unit electric wire can be reduced by the largest amount. Based on this, it is deemed that the unit electric wire 251 that can suppress the proximity effect caused at the center of the unit electric wire also has a similar effect.

Next, the unit electric wire B has the increase of the resistance smaller than that of the unit electric wire A in the high-frequency band. In other words, the increase of the alternating-current resistance by forming the unit electric wire by bundling each predetermined number of conductive wires is reduced more than the increase of the alternating-current resistance by forming the unit electric wire by bundling together a plurality of conductive wires.

Next, to check an electromagnetic shielding ability of the corrugated tube 13 of the present invention, an electric field strength generated around the power supply wire 1 for high-frequency current is measured using a coil-shaped current probe (TEGAM93686-1) and a spectrum analyzer (hp 8563E). The measurement result is indicated in Table 1 below. Here, an output voltage of an oscillator is 0.1V (0.2828Vpp).

TABLE 1

| | | | | | Leakage |
|---|---|---|---|---|---|
| | | | | | current when |
| | | | Electric | | passing current |
| | | Passing | field | Leakage | is 50 A (mA) |
| | Frequency | current | strength | current | (predicted |
| | (kHz) | (A) | (dBμV) | (μA) | value) |
| Without | 30 | 0.083 | 25.50 | 10.13 | 6.10 |
| corrugated | 100 | 0.099 | 36.92 | 33.23 | 16.78 |
| tube | | | | | |
| Aluminum | 30 | 0.083 | 23.58 | 8.12 | 4.89 |
| corrugated | 100 | 0.099 | 32.25 | 19.41 | 9.80 |
| tube | | | | | |
| Iron | 30 | 0.083 | 9.00 | 1.52 | 0.91 |
| corrugated | 100 | 0.099 | 22.17 | 6.08 | 3.07 |
| tube | | | | | |

According to the above result, the electric field strength generated from the power supply wire 1 for high-frequency current having the aluminum corrugated tube 13 is small as compared with the electric field strength generated from the power supply wire 1 for high-frequency current without the corrugated tube 13 (electric field strength generated from the combined electric wire). For this reason, it can be said that even the corrugated tube 13 made of a non-magnetic material has an electromagnetic shielding ability. In addition, the electric field strength generated from the power supply wire 1 for high-frequency current having the iron corrugated tube 13 is the smallest. From this result, it can be said that the electromagnetic shielding ability of the corrugated tube 13 made of a magnetic material such as iron is the highest. Accordingly, it is preferable to use the corrugated tube 13 made of the magnetic material for the power supply wire 1 for high-frequency current of the present invention.

The power supply wire for high-frequency current of the present invention has been described above. However, it is to be understood that the present invention may be practiced in an embodiment in which various modifications, alterations, or variations are added based on knowledge of a person having an ordinary skill in the art without departing from the gist of the present invention.

This application claims priority from Japanese Patent Application No. 2011-246743, which is incorporated herein by reference.

What is claimed is:

1. A power supply wire for high-frequency current, comprising:
a corrugated tube made of metal;
a combined electric wire disposed inside the corrugated tube and including a plurality of unit electric wires and a sheath material, each of the unit electric wires being formed by bundling together a plurality of conductive wires individually coated with insulating films, and the sheath material covering the plurality of unit electric wires; and
a gap formed between the corrugated tube and the combined electric wire.

2. The power supply wire for high-frequency current according to claim 1, wherein the unit electric wire includes a plurality of conductive wire bundles each of which is formed by bundling together the plurality of conductive wires.

3. The power supply wire for high-frequency current according to claim 2, wherein the plurality of conductive wire bundles are arranged annularly.

4. The power supply wire for high-frequency current according to claim 3, wherein a non-magnetic space support filler is provided at a center of the plurality of conductive wire bundles.

5. The power supply wire for high-frequency current according to claim 1, wherein a gap is provided with a spacer that extends in a length direction of the corrugated tube along an outer circumference of the combined electric wire.

6. The power supply wire for high-frequency current according to claim 1, comprising a plurality of the power supply wires for high-frequency current, wherein the plurality of the power supply wires for high-frequency current are integrated by an external layer material.

7. The power supply wire for high-frequency current according to claim 1, wherein the power supply wire for high-frequency current is connected to a coil, and the number of the unit electric wires connected to one terminal of the coil and the number of the unit electric wires connected to the other terminal of the coil are equal to each other.
